(19) United States
(12) Patent Application Publication
(10) Pub. No.: US 2007/0130185 A1
(43) Pub. Date: Jun. 7, 2007

(54) Efficient deletion of leaf node items within tree data structure

(76) Inventors: John F. Miller III, Lake Oswego, OR (US); Hyun-Ju Vega, Portland, OR (US)

Correspondence Address: LAW OFFICES OF MICHAEL DRYJA, 704 228TH AVE NE, #694, SAMMAMISH, WA, 98074, US

(21) Appl. No.: 11/294,078

(22) Filed: Dec. 4, 2005

(51) Int. Cl. G06F 7/00

(52) U.S. Cl. 707/101

(57) ABSTRACT

Leaf node items within a tree data structure are efficiently deleted. A leaf node item of a leaf node of the tree data structure is marked for deletion. The leaf node is marked as containing leaf node items that have been marked for deletion. A flag for a region encompassing the leaf node within a linear representation of the tree data structure is set. The linear representation of the tree data structure has a number of regions, each of which encompass one or more of the leaf nodes and that have a corresponding flag. Periodically, the tree data structure is cleaned. Each region of the linear representation for which the corresponding flag is set is scanned for leaf nodes that have been marked as containing leaf node items that have been marked for deletion. Each such leaf node item that within each such leaf node is found is deleted.

### FIELD OF THE INVENTION

The present invention relates generally to a tree data structure, such as a tree data structure having leaf nodes and leaf node items, and more particularly to efficiently deleting leaf node items within such a tree data structure.

### BACKGROUND OF THE INVENTION

Tree data structures are commonly employed in computer systems to increase the speed at which stored data is retrieved. For instance, tree data structures are frequently used to store data on hard disk drives of computer systems, as well as within semiconductor memory of computer systems. A tree data structure includes a root node, and typically has a number of branch nodes, each of which extends from the root node or from another branch node. A tree data structure also has a number of leaf nodes. Each leaf node extends from the root node or from a branch node. A leaf node does not have any other nodes extending from it, however. Leaf nodes each include zero or more leaf node items. A leaf node item can store a delete flag, to indicate that the item is to be deleted, as well as data and/or an address to data represented by the leaf node item. A leaf node itself can also store a delete flag to indicate that it contains one or more leaf node items that have been marked for deletion.

Deletion of leaf nodes items within a tree data structure is typically a two-stage process. First, a delete operation is performed in which a leaf node item is marked for deletion. That is, the delete flag of the leaf node item is set, and the delete flag of the leaf node encompassing the leaf node item is also set, if it has not been set already due to another leaf node item within the same leaf node having been previously marked for deletion. Performance of this operation does not actually delete the leaf node item, however. That is, marking a leaf node item for deletion does not actually free up the space (e.g., hard disk drive space, or memory space) occupied by the leaf node item. Rather, the leaf node item in question still occupies hard disk drive or memory space.

In the second stage of the process, the tree data structure is scanned for leaf nodes that have had their delete flags set and thus have been marked as containing one or more leaf node items marked for deletion. Each leaf node item that has been marked for deletion within each such leaf node that has been found is then actually deleted during this second stage. For instance, the hard disk drive or memory space occupied by the leaf node is freed by actually deleting the leaf node item. This process is commonly part of a “garbage collection” routine that is periodically performed to free up hard disk drive or memory space that is no longer being actively used within the computer system.

Within the prior art, there are two general types of scanning processes that can be performed to scan a tree data structure for leaf nodes that have had at least one of their leaf node items marked for deletion. First, the tree data structure may itself be traversed on a leaf node-by-leaf node basis to look for leaf nodes having leaf node items that have been marked for deletion. This process is known as “leaf scanning.” Leaf scanning, however, employs a large number of input/output (I/O) resources when performed on particularly large tree data structures having large numbers of leaf nodes, since each leaf node must be examined to determine whether it has any leaf node items that have been marked for deletion, even if only a few leaf nodes have leaf node items that are marked for deletion.

Second, a range scanning approach can be employed to scan a tree data structure for leaf nodes that have leaf node items that have been marked for deletion. A tree data structure, for instance, may occupy a certain range of addresses that are contiguous or non-contiguous, which is referred to herein as the global range for descriptive clarity. When a leaf node item is marked for deletion in the first stage of the process, one of two pointers may be updated. First, if the leaf node encompassing the leaf node item has an address within the global range that is the lowest address of any leaf node having a leaf node item marked for deletion since the last scanning has occurred, this lowest address is remembered. Second, if the leaf node has an address within the global range that is the highest address of any leaf node having a leaf node item marked for deletion since the last scanning has occurred, this highest address is remembered.

Therefore, when range scanning occurs, just the leaf nodes having addresses in the range between the lowest address of any leaf node having a leaf node item marked for deletion and the highest address of any leaf node having a leaf node item marked for deletion is scanned for leaf nodes that are marked for deletion. In other words, not all the addresses of the global range of addresses occupied by the tree data structure are necessarily examined. Therefore, range scanning can improve I/O performance as compared to leaf scanning.

However, range scanning can still consume a large amount of I/O resources if the lowest address and the highest address of the leaf nodes having leaf node items marked for deletion represent a large range of addresses. For example, a tree data structure may itself occupy a global range of address having a lowest address TREE_LOW and a highest address TREE_HIGH. By coincidence, a first leaf node having a leaf node item marked for deletion may be located at the address TREE_LOW, and a second leaf node having a leaf node item marked for deletion may be located at the address TREE_HIGH. Therefore, range scanning in this worst-case situation has to examine all the addresses within the global range of the tree data structure when looking for leaf nodes that have leaf node items marked for deletion. In this worst-case situation, I/O performance is no better than leaf scanning.

While the worst-case situation may not occur frequently, other worse case situations are likely to occur with sufficient frequency to cause I/O performance to degrade when performing range scanning. That is, only a few leaf nodes may have leaf node items marked for deletion, and these leaf nodes may have addresses that are relatively spread out from one another within the global range of addresses occupied by the tree data structure itself. This means that the range-scanning process will have to scan a large portion of the global range of the tree data structure to locate only a few leaf nodes that have leaf node items marked for deletion. While this process may have better performance than leaf scanning, since the entire global range occupied by the tree data structure itself is not scanned, it still has relatively poor performance, since many more leaf nodes that do not have leaf node items marked for deletion are scanned to locate the few leaf nodes that have leaf node items marked for deletion. That is, a large portion of the global range of the tree data structure is still nevertheless scanned to locate the leaf nodes that have leaf node items marked for deletion.

For these and other reasons, therefore, there is a need for the present invention.

### SUMMARY OF THE INVENTION

The present invention relates to the efficient deletion of leaf nodes items within a tree data structure. A method of an embodiment of the invention marks a leaf node item of a leaf node of a tree data structure for deletion, which results in the leaf node itself being marked as containing one or more leaf node items that have been marked for deletion. A flag for a region encompassing the leaf node within a linear representation of the tree data structure is set. The linear representation of the tree data structure has a number of regions, each of which encompass one or more of the leaf nodes and that have a corresponding flag. Periodically, the tree data structure is cleaned. Each region of the linear representation for which the corresponding flag is set is scanned for leaf nodes that have been marked as containing one or more leaf node items marked for deletion. Each such leaf node item that is found within such a leaf node is deleted.

A computerized system of an embodiment of the invention includes a computer-readable medium, a first mechanism, and a second mechanism. The computer-readable medium stores a tree data structure having at least a number of leaf nodes, a linear representation of the tree data structure having a number of regions that each encompass one or more of the leaf nodes, and a bitmap having a number of bits corresponding to these regions. The first mechanism is to mark a leaf node item of a leaf node for deletion, as well to mark the leaf node as containing one or more leaf node items marked for deletion, and to set a bit for a region encompassing this leaf node. The second mechanism is to periodically clean the tree data structure. For each region of the linear representation for which the corresponding bit is set, the second mechanism scans the region for leaf nodes that have been marked as containing one or more leaf node items marked for deletion. Each leaf node item that is marked for deletion and that is found within such leaf nodes is deleted.

An article of manufacture of the invention includes a tangible computer-readable medium, such as a recordable data storage medium, and means in the medium. The means is for deleting leaf node items of leaf nodes of a tree data structure by using a linear representation of the tree data structure. The linear representation has a number of regions, each of which encompasses one or more of the leaf nodes. The means further uses a bitmap having a number of bits corresponding to the number of regions. Each bit is set when a leaf node encompassed by the region to which the bit corresponds has one or more of leaf node items marked for deletion.

Embodiments of the invention provide for advantages over the prior art. Input/output (I/O) performance is improved in scanning the tree data structure for leaf nodes having leaf node items marked for deletion, because only regions of the linear representation of the tree data structure that encompass leaf nodes that have been marked as containing leaf node items marked for deletion are scanned. Whether a region encompasses one or more leaf nodes that have been marked as containing leaf node items marked for deletion is denoted by whether its corresponding flag, or bit, has been set. If a region does not encompass any leaf nodes that have been marked as containing leaf node items marked for deletion, its corresponding flag, or bit, will not be set, and this region will not be scanned for leaf nodes that have been marked as containing leaf node items marked for deletion.

Thus, the worst case in the present invention occurs where each region that has had its corresponding flag, or bit, set contains just a single leaf node having one or more leaf node items marked for deletion. Even this worst case, however, provides for better I/O performance than the worst case of the range-scanning approach of the prior art, which essentially requires scanning of all the leaf nodes. Furthermore, in some embodiments of the invention, if I/O performance is not sufficient, then the linear representation of the tree data structure can be resized so that there are fewer leaf nodes encompassed by each range of the linear representation. For instance, the number of ranges, and thus the number of flags or bits, may be increased. Resizing the linear representation therefore allows for I/O performance to be improved even in the worst case of the present invention, which is not possible in the worst case of the range-scanning approach of the prior art, for instance.

Furthermore, the linear cleaning of embodiments of the invention allows for processing large blocks of leaf nodes at a time, reducing the number of I/O operations that are performed. A single I/O operation may be able to read, or examine, many leaf nodes at a time. For example, if a region encompasses 256 leaf nodes, and there is an optimal size of 64 leaf nodes that can be read in a single I/O operation, then only 256 divided by 64, or four, I/O operations are needed to examine all the leaf nodes within the region. By comparison, employing leaf scanning would require at least 256 I/O operations, since in leaf scanning just a single leaf node is examined in each I/O operation. Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1A is a diagram of an example tree data structure and an example linear representation of the tree data structure, according to a preferred embodiment of the invention, and is suggested for printing on the first page of the patent.

FIG. 1B is a diagram of a representative leaf node, having a number of leaf node items, according to an embodiment of the invention.

FIG. 2 is a diagram of a computerized system, according to an embodiment of the invention.

FIG. 3 is a flowchart of a method for using a linear representation of a tree data structure to delete leaf nodes of the tree data structure, according to an embodiment of the invention.

FIG. 4 is a flowchart of a method for resizing the linear representation of a tree data structure used to delete leaf nodes of the tree data structure, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Overview

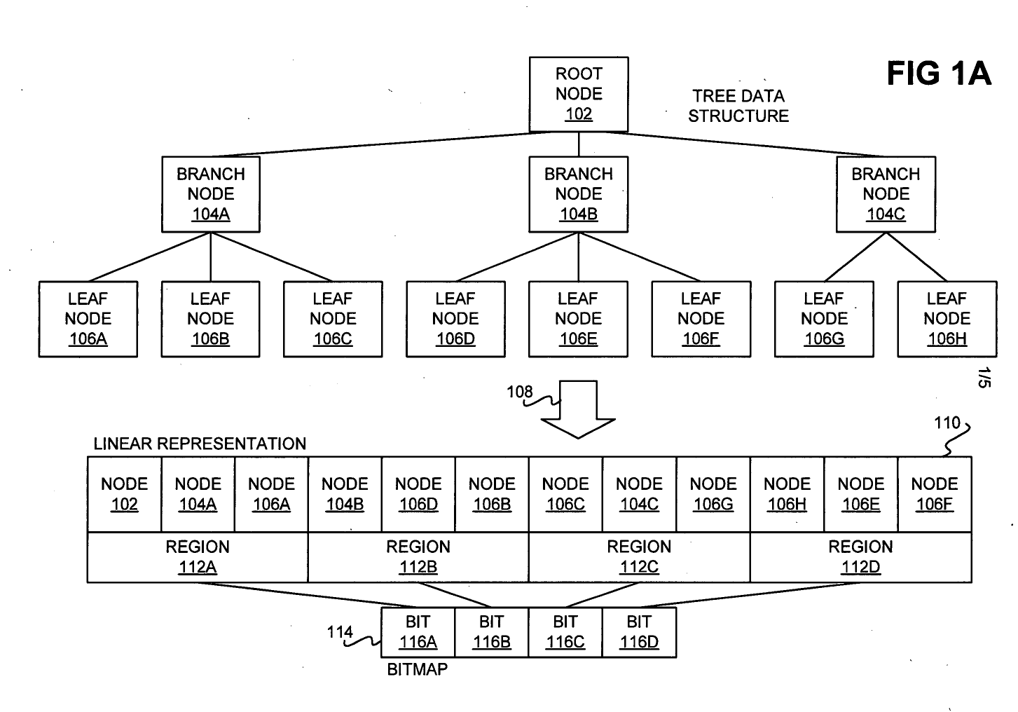

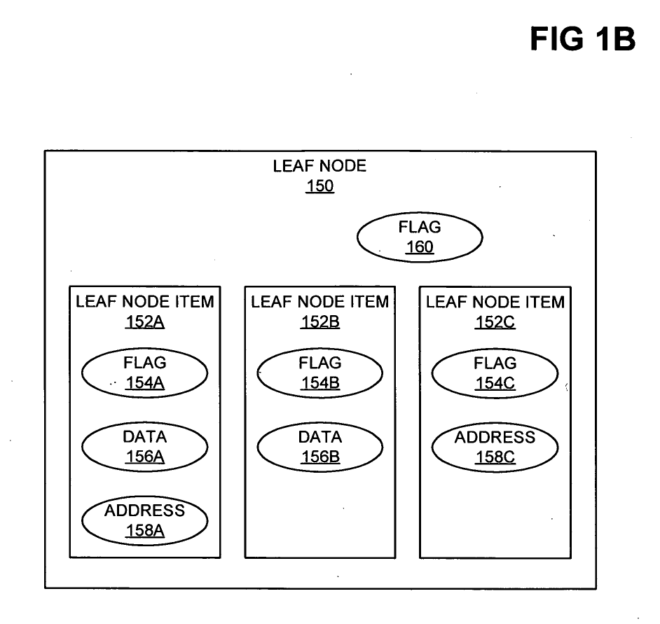

FIG. 1A shows a linear representation 110 of a tree data structure 100 that can be employed in order to efficiently delete leaf nodes items from the tree data structure 100, according to an embodiment of the invention. The tree data structure 100 in the example of FIG. 1A includes a root node 102, and branch nodes 104A, 104B, and 104C, collectively referred to as the branch nodes 104. The tree data structure 100 in the example of FIG. 1A also includes leaf nodes 106A, 106B, 106C, 106D, 106E, 106F, 106G, and 106H, collectively referred to as the leaf nodes 106. As can be appreciated by those of ordinary skill within the art, the tree data structure 100 may include more or fewer of the leaf nodes 106 and the branch nodes 104, arranged differently than is depicted in FIG. 1A. As such, the tree data structure 100 is an example of a tree data structure 100 in relation to which the efficient deletion of one or more leaf node items within the leaf nodes 106 is described.

The root node 102 of the tree data structure 100 is defined as the node from which all other nodes of the structure 100 ultimately extend, either directly or indirectly, and which itself does not extend from any other node. By definition, there is just one root node within a tree data structure. The branch nodes 104 of the tree data structure 100 are each defined as a node that directly extends from the root node 102 or from another branch node, and from which one or more leaf nodes 106 and/or one or more other branch nodes directly extend. In the example of FIG. 1A, all of the branch nodes 104 extend directly from the root node 102, and none of the branch nodes 104 directly extend from other of the branch nodes 104. The leaf nodes 106 of the tree data structure 100 are each defined as a node that directly extends from the root node 102 or from one of the branch nodes 104, and from which no other nodes extend. In the example of FIG. 1A, all of the leaf nodes 106 extend directly from the branch nodes 104, and none of the leaf nodes 106 directly extend from the root node 102.

FIG. 1B shows a representative leaf node 150, having a number of leaf node items 152A, 152B, and 152C, collectively referred to as the leaf node items 152, according to an embodiment of the invention. The leaf node 150 is representative in that it exemplarily represents any of the leaf nodes 106 of FIG. 1A. While the leaf node 150 is depicted as having three leaf node items 152, in actuality there may be fewer or more leaf node items for any given leaf node. For instance, there may be as few as no leaf node items for a given leaf node, or more than three leaf node items for a given leaf node.

A leaf node item may store a delete flag, to indicate that the item is to be deleted, as well as data and/or an address to data represented by the leaf node item. Thus, the leaf node item 152A of the leaf node 150 includes a delete flag 154A, data 156A, and an address 158A. The delete flag 154A is set, or marked, when the leaf node item 152A is to be deleted. The data 156A is a portion of the data of the leaf node item 152A. The address 158A is a pointer to another location at which other data of the leaf node item 152A is stored.

The leaf node item 152B of the leaf node 150, by comparison, includes a delete flag 154B and data 156B, but no address. The delete flag 154B is set, or marked, when the leaf node item 152B is to be deleted. The data 156B includes all the data of the leaf node item 152B, because there is no address that that points to another location at which other data of the leaf node item 152B is stored. Finally, the leaf node item 152C of the leaf node 150 includes a delete flag 154C and an address 158C, but no data within the leaf node item 152C itself. The delete flag 154C is set, or marked, when the leaf node item 152C is to be deleted. The address 158C is a pointer to another location, outside of the leaf node item 152C itself, at which all the data of the leaf node item 152C is stored, since there is no data within the leaf node item 152C itself, in contradistinction to the leaf node items 152A and 152B, for instance.

Furthermore, the leaf node 150 also includes a delete flag 160. When any of the delete flags 154 of the leaf node items 154 are set, the delete flag 160 is also set. That is, the delete flag 160 indicates that the leaf node 150 contains one or more leaf node items that have been marked for deletion. The delete flag 160 does not indicate that the leaf node 150 itself is to be deleted, but rather just that one or more leaf node items of the leaf node 150 are to be deleted. After the leaf node items in question have been deleted, the delete flag 160 is then reset. Therefore, when a given leaf node item of the leaf node 150 is marked for deletion, the flag 160 is also set, or the flag 160 has already been set, by virtue of another leaf node item of the leaf node 150 having already been marked for deletion.

Referring back to FIG. 1A, in embodiments of the invention, the tree data structure 100 is represented by a linear representation 110 thereof, as indicated by the arrow 108. The linear representation 110 of the tree data structure 100 has a number of regions 112A, 112B, 112C, and 112D, collectively referred to as the regions 112. Each of the regions 112 of the linear representation 110 encompasses a number of the nodes 102, 104, and 106 of the tree data structure 100. As depicted in FIG. 1A, each of the regions 112 encompasses three of the nodes 102, 104, and 106 of the tree data structure, and there are four regions 112 within the linear representation in FIG. 1A. However, this is just for example purposes, and in actuality there is likely to be many more regions, with many more tree data structure nodes encompassed by each region.

In one embodiment, the nodes 102, 104, and 106 of the tree data structure 100 are ordered within the linear representation 110 in the order in which the nodes are actually physically stored on a computer-readable medium, such as an input/output (I/O) storage medium. Such a storage medium may be a hard disk drive, or another type of storage or computer-readable medium. For instance, the nodes 102, 104, and 106 of the tree data structure 100 may be ordered within the linear representation 110 in the order of their physical addresses on the storage medium.

Therefore, the region 112A encompasses the nodes 102, 104A, and 106A, corresponding to the physical order of these nodes on the storage medium, such as the order of the physical addresses of these nodes. For instance, the node 102 has a first address, the node 104A has a second address greater than the first address, and the node 106A has a third address greater than the second address. The region 112B encompasses the nodes 104B, 106D, and 106B, also corresponding to the physical order of these nodes on the storage medium, such as the order of the physical addresses of these nodes. For instance, the node 104B has a fourth address greater than the third address of the node 106A of the region 112A, the node 106D has a fifth address greater than the fourth address, and the node 106B has a sixth address greater than the fifth address.

Likewise, the region 112C encompasses the nodes 106C, 104C, and 106G, corresponding to the physical order of these nodes on the storage medium, such as the order of the physical addresses of these nodes. For instance, the node 106C has a seventh address greater than the sixth address of the node 106B of the region 112B, the node 104C has an eighth address greater than the seventh address, and the node 106G has a ninth address greater than the eighth address. The region 112D encompasses the nodes 106H, 106E, and 106F, also corresponding to the physical order of these nodes on the storage medium, such as the order of the physical addresses of these nodes. For instance, the node 106H has a tenth address greater than the ninth address of the node 106G of the region 112C, the node 106E has an eleventh address greater than the tenth address, and the node 106F has a twelfth address greater than the eleventh address.

A bitmap 114 corresponds to the linear representation 110 of the tree data structure 100. The bitmap 114 has a number of bits 116A, 116B, 116C, and 116D, collectively referred to as the bits 116 that correspond to the regions 112 of the linear representation 110. When a leaf node encompassed by one of the regions 112 has one or more of its leaf node items marked for deletion, one of the bits 116 corresponding to this region is correspondingly set. For example, if the leaf node 106C has one or more of its leaf node items marked for deletion, then the bit 116C would be set, because the region 112C, to which the bit 116C corresponds, encompasses the leaf node 106C. The bits 116 of the bitmap 114 are more generally referred to as flags.

Therefore, deletion of the leaf node items of the leaf nodes 106 of the tree data structure 100 occurs in a two-stage process as follows. First, each leaf node item of the leaf nodes 106 that is to be deleted is marked, such as via its corresponding delete flag being set, as has been described in relation to FIG. 1B. This also results in the leaf node encompassing or containing the leaf node item to be marked as containing one or more leaf node items marked for deletion, if it has not already been so marked by virtue of another leaf node item within the same leaf node having previously been marked for deletion. Furthermore, the bit corresponding to the region encompassing this leaf node that has one or more of its leaf node items marked for deletion is set if it has not already been set by virtue of another leaf node encompassed by that region having already had one of its leaf node items marked for deletion. Second, when the leaf node items marked for deletion are to be actually deleted, just those of the regions 112 that have had their corresponding bits set are scanned for leaf nodes that have been marked as containing leaf node items that have been marked for deletion. Each leaf node item marked for deletion that is encountered within each such leaf node is then actually deleted, such that its occupied memory or hard disk drive space is indicated as being free and thus is available for reuse.

For example, the leaf nodes 106A and 106F may each have one or more leaf node items marked for deletion, such that the leaf nodes 106A and 106F are themselves marked as containing leaf node items marked for deletion. Furthermore, as a result, the bits 116A and 116D, corresponding to the regions 112A and 112D encompassing the leaf nodes 106A and 106F, respectively, are set. Thereafter, when scanning is to occur, just the nodes encompassed by the regions 112A and 112D are scanned. During scanning, the leaf nodes 106A and 106F will be found as being marked as containing leaf node items marked for deletion, and the leaf node items within these leaf nodes and that have been marked for deletion will then be actually deleted. Scanning in this example, therefore, just scans a total of six nodes, the nodes 102, 104A, and 106A encompassed by the region 112A and the nodes 106H, 106E, and 106F encompassed by the region 112D, to locate the two leaf nodes 106A and 106F that have leaf node items that have been marked for deletion.

By comparison, for instance, the range-scanning approach of the prior art that has been described in the background section would scan in this example all the nodes within the linear representation 110 from the node 106A through the node 106F. This is because the leaf node 106A has the lowest address of any leaf node having one or more leaf node items marked for deletion, and the leaf node 106F has the highest address of any leaf node having one or more leaf node items marked for deletion. Including the nodes 106A and 106F, there are ten nodes between the nodes 106A and 106F: the nodes 106A, 104B, 106D, 106B, 106C, 104C, 106G, 106H, 106E, and 106F. Therefore, the range-scanning approach of the prior art would have to scan a total of ten nodes to locate the two leaf nodes 106A and 106F that have leaf node items marked for deletion. In this example, then, there is a 40% reduction in the number of leaf nodes that need to be scanned by employing an embodiment of the invention, since the invention needs to scan just six nodes to locate the two leaf nodes 106A and 106F that each has one or more leaf node items marked for deletion.

Technical Background and Method

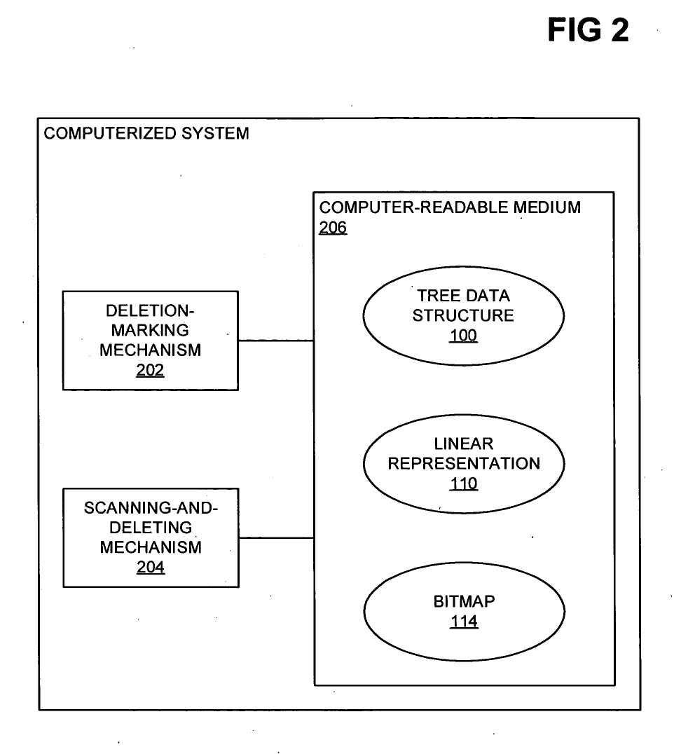

FIG. 2 shows a computerized system 200, according to an embodiment of the invention. The system 200 is depicted in FIG. 2 as including a deletion-marking mechanism 202, a scanning-and-deleting mechanism 204, and a computer-readable medium 206. The mechanisms 202 and 204 may be implemented in hardware, software, or a combination of hardware and software. For instance, the mechanisms 202 and 204 may each be one or more computer programs executed by a processor of the system 200 from a volatile semiconductor memory. The computer-readable medium 206 may in one embodiment be a non-volatile magnetic medium, such as a hard disk drive, may alternatively be a volatile semiconductor memory, such as dynamic random-access memory (DRAM), or may be another type of computer-readable medium. The computerized system 200 may further include other components, in addition to and/or in lieu of those depicted in FIG. 2.

In one embodiment, the computer-readable medium 206 may store one or more computer programs, which may be considered a means in the medium 206. The computer programs are for deleting leaf node items of leaf nodes of a tree data structure, by using a linear representation of the tree data structure that has a number of regions, as has been described. Each region encompasses one or more leaf nodes. The computer programs also delete the leaf node items by using a number of bits corresponding to the regions, as has also been described. Each bit is set when a leaf node encompassed by the region to which the bit corresponds includes one or more leaf node items marked for deletion. The computer programs may also be for initially sizing the linear representation of the tree data structure, and for periodically resizing the linear representation based on input/output (I/O) performance considerations, as is described in more detail below.

The computer-readable medium 206 also stores the tree data structure 100, the linear representation 110 of the tree data structure 100, and the bitmap 114 corresponding to the linear representation 110 that have been described. More specifically, the medium 206 can be considered as storing one or more data structures that include the tree data structure 100, the linear representation 110, and the bitmap 114. The deletion-marking mechanism 202 marks each leaf node item node of the tree data structure 100 that is to be deleted, marks each leaf node that contains one or more leaf node items marked for deletion, and further sets a bit within the bitmap 114 corresponding to the region within the linear representation 110 encompassing the leaf node in question. The scanning-and-deleting mechanism 204 periodically cleans the tree data structure 100.

In particular, the scanning-and-deleting mechanism 204 periodically scans each region of the linear representation 110 of the tree data structure 100 that has a corresponding bit within the bitmap 114 set for leaf nodes that have been marked as containing leaf node items marked for deletion. For each such leaf node located, the mechanism 204 actually deletes the leaf node items thereof that have been marked for deletion. The scanning-and-deleting mechanism 204 also performs initial sizing and subsequent resizing of the linear representation 110 of the tree data structure 100 and/or of the bitmap 114 corresponding to the linear representation 110, as is described in more detail later in the detailed description.

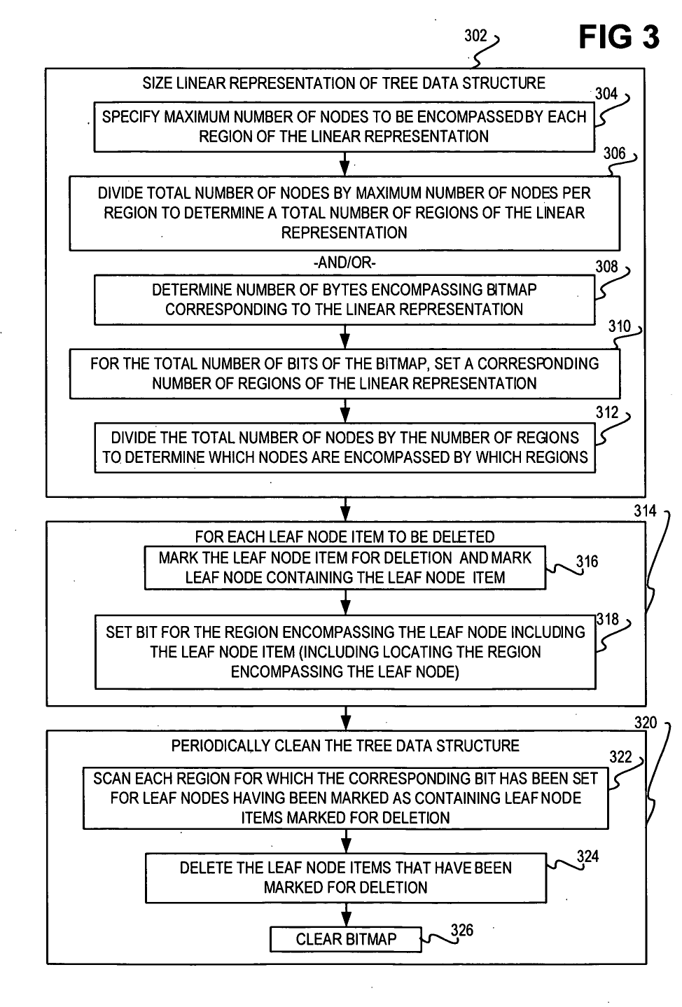

FIG. 3 shows a method 300 for using the linear representation 110 that has been described in order to efficiently delete leaf nodes items from the tree data structure 100, according to an embodiment of the invention. First, the linear representation 110 of the tree data structure 100 is initially sized (302). Initial sizing of the linear representation 110 can be accomplished in one embodiment by the scanning-and-deleting mechanism 204. Sizing of the linear representation 110 in part 302 of the method 100 can be accomplished by performing parts 304 and 306, and/or by performing parts 308, 310, and 312.

In one embodiment, the maximum number of nodes to be encompassed by each region of the linear representation 110 may be specified (304). For example, the maximum number of nodes encompassed by any region of the linear representation 110 may be specified as 50. Thereafter, the total number of nodes within the tree data structure 100 is divided by the maximum number of nodes per region to determine the total number of regions of the linear representation (306). For example, the total number of nodes within the tree data structure 100 may be 190. Because 190 divided by 50 is rounded up to the integer four, there are thus initially four regions within the linear representation 110. The first three regions each encompass the maximum number of nodes per region, 50, whereas the last region encompasses the remaining 40 nodes. Therefore, in general, all of the regions of the linear representation 110 except the last region will always initially encompass the maximum number of nodes specified per region, and the last region will initially encompass at least one node and no more than this maximum number of nodes. Based on the number of regions 112 determined, there are a corresponding number of bits 116 within the bitmap 114 corresponding to the linear representation 110.

In another embodiment, first the number of bytes encompassing the bitmap 114 that corresponds to the linear representation 110 is determined (308). It may be determined, for instance, that the number of bytes of the bitmap 114 is to be no less than eight bytes, and no more than 1,024 bytes. That is, the number of bytes within the bitmap 114 may be specified or selected within a predetermined range. Furthermore, in one embodiment, the number of bytes encompassing the bitmap 114 is specified as:

$$bytes = \frac{\frac{{I}_{size}}{{R}_{size}} + {i}_{size} {bits}_{byte}}{{i}_{size} {bits}_{byte}} \qquad ( 1 )$$

In equation (1), I_{size} is the size of the tree data structure in bytes, that is, the total number of bytes occupied by all the nodes of the tree data structure. R_{size} is a pre-specified initial size of each region of the linear representation of the tree data structure in bytes. i_{size} is the number of bytes of a given type of an integer value of the computerized system 200. For instance, some computerized systems specify an int4 type of integer that uses four bytes to represent an integer. Finally, bits_{byte} is the number of bits per byte in the computerized system 200, and is typically eight. Thus, the number of bits 116 within the bitmap 114 will be the number of bytes determined, times bits_{byte}.

Next, for the total number of bits 116 of the bitmap 114 that have been determined, a corresponding number of regions 112 within the linear representation 110 of the tree data structure 100 is set or specified (310). For example, if there are sixteen bits 116 within the bitmap 114, then there are sixteen regions 112 within the linear representation 110. Finally, the total number of nodes within the tree data structure 100 are divided by the number of regions 112 within the linear representation 110 to determine the number of nodes encompassed by each region, and which nodes are encompassed by which regions (312). In one embodiment, the nodes are ordered in the linear representation 110 in the order in which they are physically located on a computer-readable medium, like a storage medium, such as in the order of their physical addresses, as has been described. The nodes are assigned in this order to the first region until the first region has reached the maximum number of nodes, then the nodes are assigned to the second region until the second region has reached the maximum number of nodes, and so on, until all the nodes have been assigned to one of the regions 112 of the linear representation 110.

Once the initial sizing of the linear representation 110 of the tree data structure 100 has been accomplished, the following is performed for each leaf node item to be deleted (314), by, for instance, the deletion-marking mechanism 202. First, the leaf node item in question is marked for deletion (316), such as via its delete flag being set. The leaf node containing this leaf node item is also correspondingly marked as containing one or more leaf node items that have been marked for deletion, if it has not already been so marked by virtue of another leaf node item within the same leaf node having already been marked for deletion. Second, the bit for and corresponding to the region encompassing the leaf node including this leaf node item is set (318), if it has not already been set by virtue of another leaf node encompassed by this region having one or more leaf node items already marked for deletion. Thus, parts 316 and 318 of the method 300 are repeated for each leaf node item of the tree data structure 100 to be deleted, as leaf node items need to be deleted.

In one embodiment, to set the bit corresponding to the region encompassing a leaf node having a leaf node item to be deleted, the region itself has to first be located. The region number, ranging from one to the total number of regions within the linear representation 110, may be located via:

$$number = roundup ( \frac{leaf * {R}_{num}}{{N}_{num}} ) \qquad ( 2 )$$

In equation (2), roundup(x) rounds up x to a next integer value. leaf is the number of the leaf node having a leaf node item being marked for deletion, and is the number of this leaf node within the linear representation 110, from one to the total number of nodes within the tree data structure 100. For example, in the example of FIG. 1A, the leaf node 106A is node three, since it is the third node from the left within the linear representation 110, the leaf node 106G is node nine, since it is the ninth node from the left, and so on. Rₙᵤₘ is the total number of the regions within the linear representation of the tree data structure, and finally Nₙᵤₘ is the larger of the total number of nodes within the tree data structure or the optimal input/output (I/O) size times Rₙᵤₘ. The optimal I/O size is the number of leaf nodes that can be examined or read during a given I/O operation for the I/O medium on which the tree data structure 100 is being stored.

For example, with respect to the linear representation 110 of FIG. 1A, and with particular respect to the node 106A, equation (2) may be evaluated as follows. The value leaf is equal to three, since the node 106A is the third node within the linear representation 110. The value Rₙᵤₘ is equal to four, since there are four regions 112 within the linear representation 110. Finally, Nₙᵤₘ is the larger of the total number of nodes within the tree data structure 100 of FIG. 1, which is sixteen, or the optimal I/O size times Rₙᵤₘ. For instance, if the optimal I/O size is 64, meaning that 64 nodes can be read during a given I/O operation, then the optimal I/O size times Rₙᵤₘ is 64 times four, or 256. Because 256 is larger than sixteen, Nₙᵤₘ is equal to 256. Therefore, equation (2) is evaluated as

$$number = roundup ( \frac{3 * 4}{256} ) = roundup ( 0.046875 ) = 1.$$

The value 0.46875 is rounded up to one as the next highest integer. Therefore, since number is equal to one, this means that the region number encompassing the node in question, the node 106A, is the first region 112A. Examining FIG. 1A, this is seen to be correct, since the region 112A does indeed encompass the node 106A within the linear representation 110.

Periodically, the tree data structure 100 is then cleaned (320), such as part of a garbage collection process performed by the scanning-and-deleting mechanism 204. Each region having a corresponding bit that has been set is scanned for leaf nodes that have been marked as containing one or more leaf node items marked for deletion (322). The leaf node items of such leaf nodes that have been marked for deletion are then actually deleted (324). Finally, the bitmap 114 is cleared (326). That is, the bits 116 of the bitmap 114 that have been set are cleared, since the leaf node items of these leaf nodes encompassed by the regions 112 corresponding to these bits 116 that have been marked for deletion have now all been deleted.

It is noted that resizing of the linear representation 110 may periodically occur. Such resizing can improve input/output (I/O) performance, to most efficiently use the linear representation 110. Examples of when such resizing occurs, and how such resizing is accomplished is now described.

Linear Representation Resizing and Conclusion

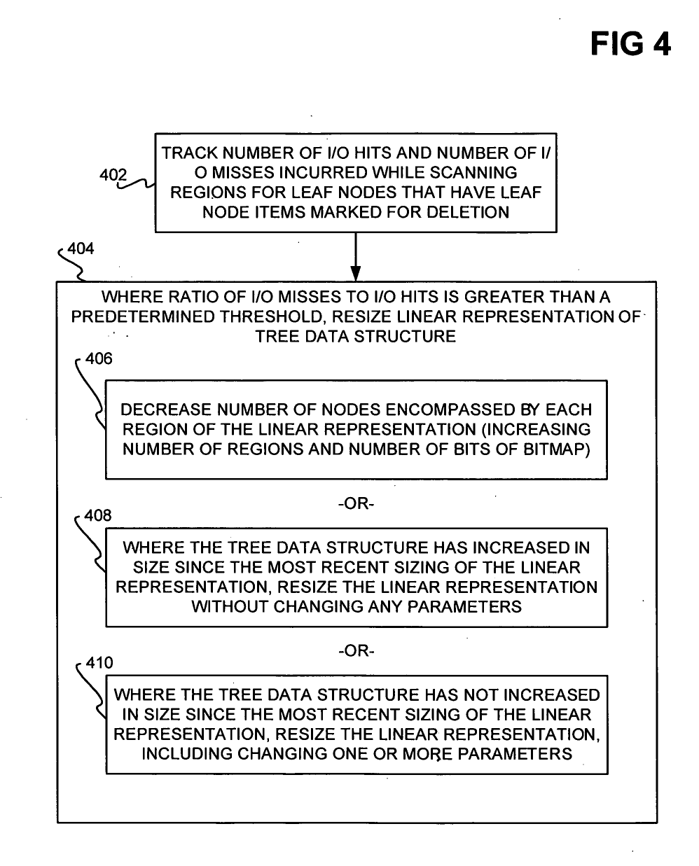

FIG. 4 shows a method 400 that is performed during and after the periodic cleaning of the tree data structure 100 in part 320 of the method 300 of FIG. 3, according to an embodiment of the invention. The method 400 may be performed by the scanning-and-deleting mechanism 204 of the computerized system 200 of FIG. 2, for instance. First, while each region of the linear representation 110 of the tree data structure 100 for which a corresponding bit of the bitmap 114 has been set is scanned for leaf nodes that have leaf node items that have been marked for deletion in part 322 of the method 300, the number of input/output (I/O) hits and the number of I/O misses incurred are tracked (402). An I/O hit is an I/O operation containing at least one leaf node that is scanned within a region of the linear representation 110 that has one or more leaf node items marked for deletion. An I/O miss is an I/O operation that contains no leaf nodes that are within a region of the linear representation 110 that has one or more leaf node items marked for deletion.

Next, after each cleaning of the tree data structure 100, where the ratio of I/O misses to I/O hits is greater than a predetermined threshold, the linear representation 110 of the tree data structure 100 is resized (404). Resizing is accomplished in order to decrease this ratio. That is, resizing is accomplished to improve I/O performance. In different embodiments of the invention, resizing may be accomplished by performing part 406, part 408, or part 410 of the method 400. In part 406, the number of nodes encompassed by each region of the linear representation 110 is decreased (406). In effect, this increases the number of regions 112 within the linear representation 110, and thus the number of bits 116 within the bitmap 114 and that correspond to the regions 112.

For example, in the example of FIG. 1A, it may be determined that the number of nodes encompassed by each of the regions 112 be decreased to a maximum of two nodes per region, from the existing three nodes per region. In such instance, to cover all twelve of the nodes of the tree data structure 100, the number of regions 112 has to increase to six, from four. Therefore, the number of bits 116 within the bitmap 114 will correspondingly increase from four to six. The new first region will encompass nodes 102 and 104A, the new second region will encompass nodes 106A and 104B, the new third region will encompass nodes 106D and 106B, and so on, where the new sixth region will encompass nodes 106E and 106F of the linear representation 110.

In another embodiment, where the tree data structure 100 has increased in size since the most recent sizing of the linear representation 110, such as the initial sizing of the linear representation 110, the linear representation 110 is resized in accordance with Equation (1) as has been described above (408). In performing this resizing, none of the parameters employed in determining the number of byte encompassing the bitmap 114—and thus the number of bits 116 within the bitmap 114 that dictates the number of regions 112 within the linear representation 110—are modified. In the case of Equation (1), there is just one parameter, the pre-specified size of each region, R_{size}. By comparison i_{size} and bits_{byte} are constants, and not considered parameters herein, whereas I_{size} is a variable equal to the size of the tree data structure in bytes, and is also not considered a parameter herein.

Therefore, since the tree data structure 100 has increased in size, such as the number of nodes within the tree data structure 100 having increased, the variable I_{size} will have increased in size as well. Therefore, the number of bytes of the bitmap 114 will increase by reapplying Equation (1). Correspondingly, the number of bits 116 of the bitmap 114 will increase, and thus the number of regions 112 within the linear representation 110 will increase, too. Once the new number of regions 112 has been determined, the nodes of the tree data structure 100 are reassigned to the new regions 112, such that each of the regions 112 may encompass a lesser number of nodes of the tree data structure 100 than before.

However, where the tree data structure 100 has not increased in size since the most recent sizing of the linear representation 110, such as the initial sizing of the linear representation 110, the linear representation 110 is resized in accordance with Equation (1), but the parameters employed in Equation (1) are modified (410). As has been described, Equation (1) has a single parameter as this term is used herein, the pre-specified size of each region, R_{Size}. To increase the number of regions 112 within the linear representation 110, the parameter R_{size} is decreased in size. That is, the size of each region is decreased. As a result, the number of bytes of the bitmap 114 increases, increasing the number of bits 116, and thus the number of regions 112 within the linear representation increases, too. As before, once this new number of regions 112 has been determined, the nodes of the tree data structure 100 are reassigned to the new regions 112, such that each region encompasses a lesser number of nodes of the tree data structure 100 than before.

As can be appreciated by those of ordinary skill within the art, resizing the linear representation 110 can be accomplished in ways other than those described herein. In general, resizing the linear representation 110 increases the number of regions 112, by decreasing the number of nodes encompassed by each of the regions 112. As a result, I/O performance is improved, because decreasing the number of nodes encompassed by each region necessarily decreases the number of I/O misses that will be incurred in scanning the region for leaf nodes marked for deletion.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. For example, the methods of different embodiments of the invention that have been described can be implemented as computer programs that are stored on computer-readable media of articles of manufacture. Such computer-readable media may be tangible computer-readable media, like recordable data storage media. Therefore, it is manifestly intended that this invention be limited only by the claims and equivalents thereof.

I claim:

1. A method comprising:
marking a leaf node item of a leaf node of a plurality of leaf nodes of a tree data structure for deletion;
marking the leaf node as containing one or more leaf node items that have been marked for deletion;
setting a flag for a region encompassing the leaf node within a linear representation of the tree data structure, the linear representation of the tree data structure having a plurality of regions, each region encompassing one or more of the leaf nodes and having a corresponding flag;
periodically cleaning the tree data structure, by:
for each region of the linear representation for which the corresponding flag is set, scanning the region for leaf nodes of the tree data structure that have been marked for deletion; and,
for each leaf node that has been marked as containing one or more leaf node items marked for deletion, deleting the leaf node items that have been marked for deletion within the leaf node.

2. The method of claim 1, further comprising initially sizing the linear representation of the tree data structure.

3. The method of claim 2, wherein initially sizing the linear representation of the tree data structure comprises:
specifying a maximum number of nodes to be encompassed by each region of the linear representation; and,
dividing a total number of nodes by the maximum number of nodes to determine a total number of the regions of the linear representation of the tree structure.

4. The method of claim 2, wherein initially sizing the linear representation of the tree data structure comprises determining a number of bytes encompassing the flags to which the regions of the linear representation correspond.

5. The method of claim 4, wherein determining the number of bytes encompassing the flags to which the regions of the linear representation correspond comprises selecting the number of bytes between a range of eight bytes and 1,024 bytes.

6. The method of claim 4, wherein determining the number of bytes encompassing the flags to which the regions of the linear representation correspond comprises determining the number of bytes as
$$\frac{\frac{{I}_{size}}{{R}_{size}} + {i}_{size} {bits}_{byte}}{{i}_{size} {bits}_{byte}} ,$$
where I_{size} size is a size of the tree data structure in bytes, R_{size} is an initial size of each region of the linear representation of the tree data structure in bytes, i_{size} is a number of bytes of an integer value, and bits_{byte} is a number of bits per byte.

7. The method of claim 1, wherein setting the flag for the region encompassing the leaf node within the linear representation of the tree data structure comprises locating the region encompassing the leaf node.

8. The method of claim 7, wherein locating the region encompassing the leaf node comprises determining the region as roundup
$$( \frac{leaf * {R}_{num}}{{N}_{num}} ) ,$$
where roundup(x) rounds up x to a next integer value, leaf is a number of the leaf node having one or more leaf nodes marked for deletion, Rₙᵤₘ is a total number of the regions within the linear representation of the tree data structure, and Nₙᵤₘ is a larger of a total number of nodes within the tree data structure and an optimal input/output (I/O) size times Rₙᵤₘ.

9. The method of claim 1, further comprising:
tracking a number of input/output (I/O) misses and a number of I/O hits incurred when scanning each region for leaf nodes that have one or more leaf node items that have been marked for deletion; and,
where a ratio of the I/O misses to the I/O hits is greater than a predetermined threshold, resizing the linear representation of the tree data structure.

10. The method of claim 9, wherein resizing the linear representation of the tree data structure comprises decreasing a number of the nodes encompassed by each region of the linear representation of the tree data structure, such that a number of the regions of the linear representation of the tree data structure is increased.

11. The method of claim 9, wherein resizing the linear representation of the tree data structure comprises, where the tree data structure has increased in size since initial sizing of the linear representation of the tree data structure, resizing the linear representation of the tree data structure without changing any parameters on which basis initial sizing of the linear representation of the tree data structure was performed.

12. The method of claim 9, wherein resizing the linear representation of the tree data structure comprises, where the tree data structure has not increased in size since initial sizing of the linear representation of the tree data structure, resizing the linear representation of the tree data structure, including changing one or more parameters on which basis initial sizing of the linear representation of the tree data structure was performed.

13. A computerized system comprising:
one or more data structures including:
a tree data structure having at least a plurality of leaf nodes;
a linear representation of the tree data structure having a plurality of regions, each region encompassing one or more of the leaf nodes;
a bitmap having a plurality of bits corresponding to the regions of the linear representation of the tree data structure;
a first mechanism to mark a leaf node item of a leaf node for deletion, to mark the leaf node as containing one or more leaf node items marked for deletion, and to set a bit for a region encompassing the leaf node; and,
a second mechanism to periodically clean the tree data structure by, for each region of the linear representation for which the corresponding bit is set, scanning the region for leaf nodes of the tree data structure that have been marked as containing one or more leaf node items marked for deletion, and for each leaf node that has been marked as containing one or more leaf node items marked for deletion, deleting the leaf node items marked for deletion within the leaf node.

14. The computerized system of claim 13, wherein the computer-readable medium is a non-volatile magnetic medium.

15. The computerized system of claim 13, wherein the second mechanism is further to initially size the linear representation of the tree data structure by determining a number of bytes of the bitmap.

16. The computerized system of claim 13, wherein the second mechanism is further to track a number of input/output (I/O) misses and a number of I/O hits incurred when scanning each region for leaf nodes that have been marked for deletion, and, where a ratio of the I/O misses to the I/O hits is greater than a predetermined threshold, to resize the linear representation of the tree data structure.

17. The computerized system of claim 16, wherein the second mechanism to resize the linear representation of the tree data structure by, where the tree data structure has increased in size since initial sizing of the linear representation of the tree data structure, resizing the linear representation of the tree data structure without changing any parameters on which basis initial sizing of the linear representation of the tree data structure was performed.

18. The computerized system of claim 16, wherein the second mechanism to resize the linear representation of the tree data structure by, where the tree data structure has not increased in size since initial sizing of the linear representation of the tree data structure, resizing the linear representation of the tree data structure, including changing one or more parameters on which basis initial sizing of the linear representation of the tree data structure was performed.

19. An article of manufacture comprising:
a tangible computer-readable medium; and,
means in the medium for deleting leaf node items of a plurality of leaf nodes of a tree data structure by using a linear representation of the tree data structure having a plurality of regions, each region encompassing one or more of the leaf nodes, and by using a bitmap having a plurality of bits corresponding to the plurality of regions, each bit being set when a leaf node encompassed by the region to which the bit corresponds includes one or more leaf node items marked for deletion.

20. The article of manufacture of claim 19, wherein the means in the medium is further for initially sizing the linear representation of the tree data structure, and for periodically resizing the linear representation of the tree data structure based on input/output (I/O) performance considerations.
